(19) United States
(12) Patent Application Publication
(10) Pub. No.: US 2026/0057596 A1
(43) Pub. Date: Feb. 26, 2026

(54) MATERIAL SELECTION AND APPLICATION FOR THREE-DIMENSIONAL ("3D") SURFACE TEXTURING USING LARGE LANGUAGE MODELS ("LLMS")

(71) Applicant: Adobe Inc., San Jose, CA (US)

(72) Inventors: Valentin Deschaintre, London (GB); Vladimir Kim, Seattle, WA (US); Thibault Groueix, San Francisco, CA (US); Rosalie Martin, Lyon (FR); Romain Rouffet, Lyon (FR); Duygu Ceylan Aksit, London (GB)

(21) Appl. No.: 18/815,692

(22) Filed: Aug. 26, 2024

(51) Int. Cl. G06T 15/04; G06T 5/40; G06T 7/10

(52) U.S. Cl. CPC G06T 15/04; G06T 5/40; G06T 7/10

(57) ABSTRACT

Techniques for texturing three-dimensional (“3D”) surfaces using large language models (“LLMs”) are disclosed. A computing system receives information about a 3D surface. The computing system determines one or more segments of the 3D surface based on the information about the 3D surface. The computing system provides, to an LLM, a prompt including the one or more segments. The computing system receives, from the LLM, a material type associated with each of the one or more segments. The computing system determines, using a materials database, a material for each of the one or more segments based on the associated material type. The computing system renders an image of the 3D surface, in which the rendered image shows each segment of the one or more segments with the determined material applied.

### TECHNICAL FIELD

This disclosure generally relates to texturing of 3D surfaces, and, more specifically, to techniques for material selection and application for 3D surface texturing using LLMs.

### BACKGROUND

Texturing of 3D surfaces is an important step during the development of 3D assets for various 3D graphics applications such as games, simulations, and generating visual effects. Texturing may involve mapping an image or characteristic (e.g., colors, patterns, materials, etc.) onto a 3D model's surface to provide it with detailed color, pattern, or surface characteristics when rendered using a particular camera and lighting configuration. Effective texturing can enhance the realism and visual appeal of the rendered 3D surfaces.

Textures can be manually applied using 3D graphics tools. For example, a 3D graphic artist may select a particular texture and use a 3D graphics tool to apply the particular texture to a portion of a 3D surface. The 3D graphics tool can be used to render the textured 3D surface under specified lighting conditions or according to other configurations. Manual application of textures, however, is cumbersome and time-consuming, particularly for 3D surfaces that are detailed or when realistic-appearing renderings are required. Consequently, automated methods for application of textures to 3D surfaces are typically used.

### SUMMARY

Some embodiments described herein relate to techniques for material selection and application for 3D surface texturing using LLMs. In an example method, a computing system receives information about a 3D surface. The computing system determines one or more segments of the 3D surface based on the information about the 3D surface. The computing system provides, to an LLM, a prompt including the one or more segments. The computing system receives, from the LLM, a material type associated with each of the one or more segments. The computing system determines, using a materials database, a material for each of the one or more segments based on the associated material type. The computing system renders an image of the 3D surface, in which the rendered image shows each segment of the one or more segments with the determined material applied.

An example system includes one or more processors and one or more computer-readable storage media storing instructions which, when executed by the one or more processors, cause the one or more processors to perform operations including receiving information about a three-dimensional 3D surface, including information about one or more base textures and a specification of a 3D mesh. The operations further include determining one or more segments of the 3D surface based on the information about the 3D surface. The operations further include determining, using an LLM, a material type associated with each of the one or more segments. The operations further include determining, using a materials database, a material for each of the one or more segments based on the associated material type. The operations further include rendering an image of the 3D surface, in which the rendered image shows each segment of the one or more segments with the determined material applied.

An example non-transitory computer-readable medium storing instructions that, when executed by one or more processors, cause the one or more processors to perform operations including receiving information about a 3D surface, including information about one or more base textures and a specification of a 3D mesh. The operations further include a step for determining one or more segments of the 3D surface based on the information about the 3D surface. The operations further include a step for providing, to an LLM, a prompt including the one or more segments. The operations further include receiving, from the LLM, a material type associated with each of the one or more segments. The operations further include a step for determining, using a materials database, a material for each of the one or more segments based on the associated material type. The operations further include a step for rendering an image of the 3D surface, in which the rendered image shows each segment of the one or more segments with the determined material applied.

These illustrative embodiments are mentioned not to limit or define the disclosure, but to provide examples to aid understanding thereof. Additional embodiments are discussed in the Detailed Description, and further description is provided there.

### BRIEF DESCRIPTION OF THE DRAWINGS

Features, embodiments, and advantages of the present disclosure are better understood when the following Detailed Description is read with reference to the accompanying drawings.

FIG. 1 is a diagram of an example system implementing techniques for material selection and application for 3D surface texturing using LLMs, according to some examples of the present disclosure.

FIG. 2D shows an illustration 200 of an untextured 3D mesh, according to some examples of the present disclosure.

FIG. 2B shows an illustration of a 3D mesh textured using base textures, according to some examples of the present disclosure.

FIG. C shows an illustration of a rendered 3D surface with material applied, according to some examples of the present disclosure.

FIG. 3 shows an example of a segmented 3D surface, according to some examples of the present disclosure.

FIGS. 4A and 4B show example prompts for material selection and application for 3D surface texturing using LLMs, according to some examples of the present disclosure.

FIGS. 5A and 5B show example material type responses from an LLM for material selection and application for 3D surface, according to some examples of the present disclosure.

FIG. 6 is a flow diagram of an example process for material selection and application for 3D surface texturing using LLMs.

FIG. 7 depicts an example of a computer system used in some examples material selection and application for 3D surface texturing using LLMs, according to some aspects of the present disclosure.

### DETAILED DESCRIPTION

Efficient texturing of 3D surfaces is a key step during the development of 3D assets for use in video games, simulations, and visual effects, and so on. Techniques for texturing of 3D surfaces may be optimized to achieve a high degree of realism and accuracy constrained by the time and resources available to develop the 3D assets. For example, some existing approaches may involve manually “painting” textures onto 3D surfaces. However, manual texturing of 3D surfaces can be cumbersome or time-consuming, particularly for highly detailed 3D surfaces or in production contexts when manual texturing is impractical. Thus, automated methods for application of textures to 3D surfaces are typically used in production, where manual selection and application of textures is impractical or otherwise undesirable.

Various approaches for automated selected and application of textures for 3D surfaces can be used. For example, some existing approaches to texturing focus on synthesizing 3D textures from existing images using image synthesis techniques. These methods may rely on hand-crafted 3D geometric and image priors (e.g., assumptions about the geometry of the 3D surface or the visual characteristics of images). Such approaches are generally limited to simple patterns and often fail to closely match the texture details to the 3D surface geometry and or its semantic parts. Some related techniques involve transferring textures from images of similar objects, but such techniques rely heavily on human annotation or brittle methods of automatic annotation.

Some existing approaches involve using machine learning (“ML”) models (e.g., autoencoders, multi-layer perceptron, etc.) to generate textures for a given 3D surface. However, these approaches are limited in their application because of the limited scope of the training data used to train the ML models. Some approaches use neural networks that can learn visual “concepts” from images using natural language supervision such as OpenAI's Contrastive Language-Image Pre-training (“CLIP”). Such neural networks can be used to texture 3D surfaces by, for example, generating images based on text-language descriptions of desired textures. However, these approaches require numerous forward passes through large vision models, which makes them relatively slow. Additionally, the architecture of these ML models limits the diversity of the textures they are able to generate. Likewise, existing approaches that use diffusion models to directly project generated pixels on the 3D surface suffer from texture bleeding and other artifacts and cannot go beyond simple red-green-blue (“RGB”) texturing. “RGB textures” refer generally to textures that are simple representations of a colored or patterned surface.

More recently, with the widespread availability of artificial intelligence (“AI”) tools such as LLMs, some existing approaches use LLMs to iteratively generate 2D images from different viewpoints. The iteratively generated 2D images can then be aggregated to constitute a texture. However, these approaches do not result in a seamless or high-quality texture. Moreover, such approaches can suffer from severe, unpredictable artifacts (e.g., both the front and back of a head being textured with faces). Furthermore, existing approaches focus on generating RGB textures with baked lighting. “Baked lighting” refers generally to textures that are not responsive to changes in lighting or viewpoint when rendered.

These and other related challenges can be overcome using techniques for material selection and application for 3D surface texturing using LLMs. Relying only on visual cues can be ambiguous when determining material types since two very different material types might have a similar appearance. Humans rely on prior knowledge of what material types are often suitable for different objects and their parts (e.g., a cushion of an armchair is likely to be made of fabric). The techniques disclosed herein are developed to take advantage of both the global context provided via creative prompting of an LLM as well as local visual cues provided using certain input images provided along with the prompt.

In one example, a segmented version of a 3D surface can be provided to an LLM along with a suitable prompt to obtain suggestions for “material” types that correspond to the segments of the 3D surface. “Material” refers generally to realistic textures that are responsive to changes in lighting or viewpoint when rendered. The suggested material types, along with rendered images of the 3D surface including base textures, can be looked up in a materials database to obtain a high-quality, relightable material that can be applied to the 3D surface and rendered under the desired conditions.

The techniques disclosed herein for material selection and application for 3D surface texturing using LLMs constitute improvements to the technical field of 3D graphics processing. In addition to overcoming the challenges outlined above, the techniques are a technical solution to a technical problem involving the automated application of realistic material textures to 3D surfaces. Moreover, the techniques can improve the functioning of computers. By automating the selection and application of textures, the techniques minimize the need for complex manual processes and iterative adjustments, thereby reducing the overall consumption of computational resources. Similarly, because an LLM is used to identify a material type, the computational burden on the 3D graphics processing workstation may be reduced, particularly in cases where a remote LLM is used.

### Overview

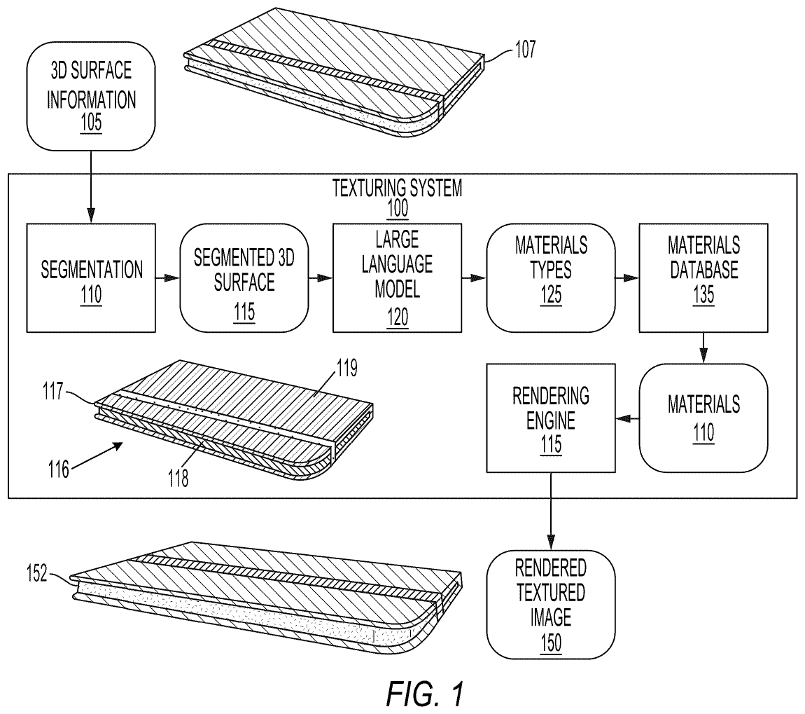

FIG. 1 is a diagram of an example system 100 implementing techniques for material selection and application for 3D surface texturing using LLMs, according to some examples of the present disclosure. FIG. 1 shows an example texturing system 100 that may include components for, for example, segmenting 3D surfaces, interfacing with an LLM, performing materials database lookups, among other functions.

The system 100 will be described with reference to a simple example to introduce certain concepts. Consider a simple digital representation of a 3D surface in the shape of a book. The 3D surface may be, for example, an asset intended for use in a 3D video game. It may be desirable to add realistic, material textures to the book so that it appears realistic in the video game and responds realistically to changes in orientation or lighting as the 3D surface is rendered.

The texturing system 100 receives 3D surface information 105 about the book. The 3D surface information 105 may include, for example, information about one or more base textures applied to the 3D surface and a specification of a 3D mesh defining the 3D surface. The one or more base textures may be, for example, simple RGB textures that characterize colors or patterns that can be applied to the 3D surface but lack the realistic appearance of material textures (e.g., the base textures may not have depth). The base textures may have lighting “baked in” and may not accurately or realistically depict the appearance of the textures under different lighting conditions or from different viewpoints. A rendered image of the example book as defined by the 3D surface information 105 is shown at book 107. The book 107 includes the one or more base textures applied to the 3D surface. The base textures can be used by the LLM 120 and materials database 135 as an indication of the desired material type or color.

Segmentation 110 receives the 3D surface information 105 and can determine a segmented 3D surface 115, including one or more segments of the 3D surface, based on the 3D surface information 105. The segments may correspond to portions of the 3D surface that will be similarly textured. For example, the 3D surface representing the book 107 may be segmented into the cover segment 117, the pages segment 118, and the strap segment 119. Segmented book 116 is shown as a rendered image.

The segmented 3D surface 115 is provided to an LLM 120 along with a prompt including instructions to determine a material type 125 for each segment of the segmented 3D surface 115. For example, the prompt 122 may be accompanied by a rendered image of the segmented 3D surface 115 (e.g., the rendered segmented book 116) and may direct the LLM to identify a color or material type 125 for each distinct segment of the accompanying image of the segmented 3D surface 115. The prompt 122 may include a variety of instructions or supplementary details such as a list of material types to choose from, a specified output format, additional imagery to guide the LLM 120 recommendation, and so on.

The LLM 120 outputs a response including one or more material types 125 corresponding to the one or more respective segments of the segmented 3D surface 115 provided to the LLM 120 as input. The materials types 125 may be output in a specified format that can be readily processed for the materials database search step described next. For example, the LLM 120 may identify a material type of “paper” for the pages segment 118 and a material type of “fabric” for the cover segment 117. An example output that identifies the object, the segment, a color, and a material is “book, pages, white, paper.”

The materials types 125 are input to a materials database 135 to identify a material 140 for each of the one or more segments of the segmented 3D surface 115 based on the associated material types 125. For example, the materials database 135 can be queried for a material using a material type 125 and an image of a segment of the rendered 3D surface including the base textures such as the rendered book 107. The materials database 135 can use the input material type 125 and image to perform a similarity search to identify a material 140 of the specified material type 125 that is similar in some respects to the input image. The material 140 may be a texture that includes additional information about how the surface interacts with light (e.g., reflectivity) and other features that may result in a more realistic rendered 3D surface.

The identified materials 140 are applied to the 3D surface and rendered by a rendering engine 145 to output a rendered textured image that shows each segment of the one or more segments of the segmented 3D surface 115 with the determined material 140 applied. During application of the materials 140, processing techniques such as normalization of the material 140 heights may be used to improve the realistic appearance of the rendered materials 140. In this example, the 3D book can be rendered with the identified materials 140 for the cover segment 117, the pages 118, and the strap 119, applied to the respective segments. The rendered 3D book 152 with materials applied can be rendered from various perspectives and under various lighting conditions and the materials 140 applied to the segments will be rendered realistically and accurately.

### Textures

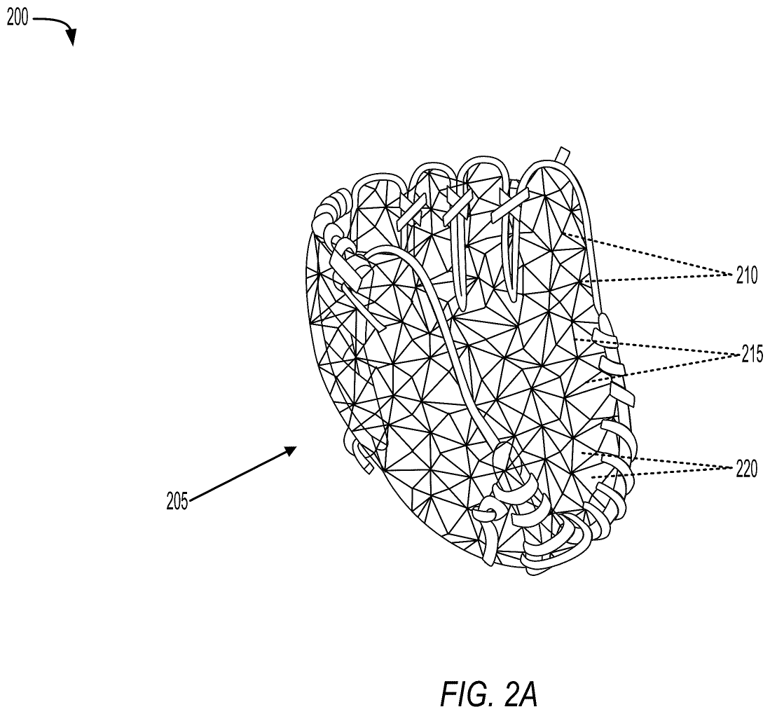

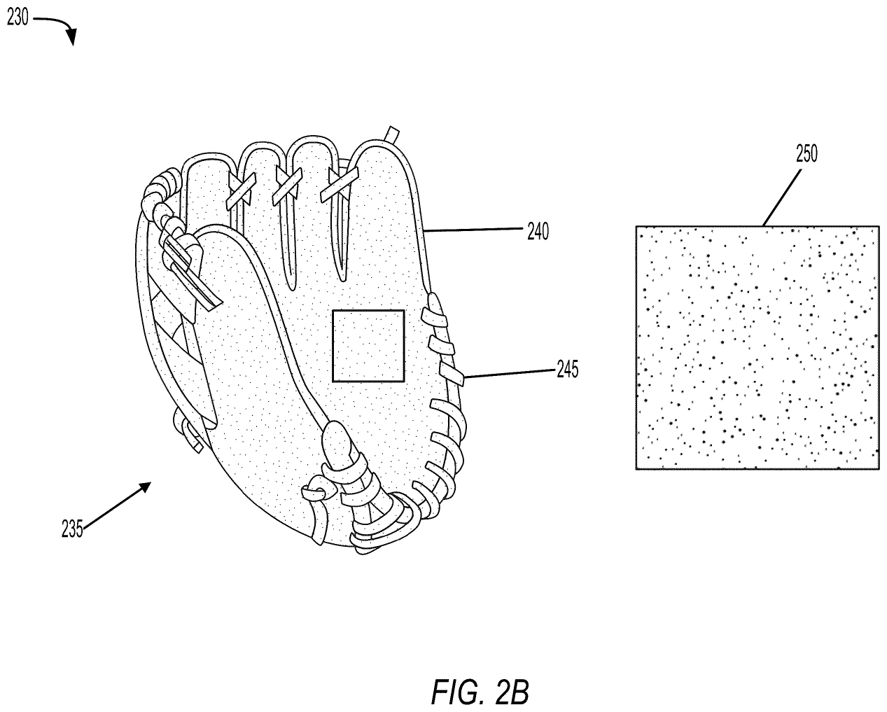

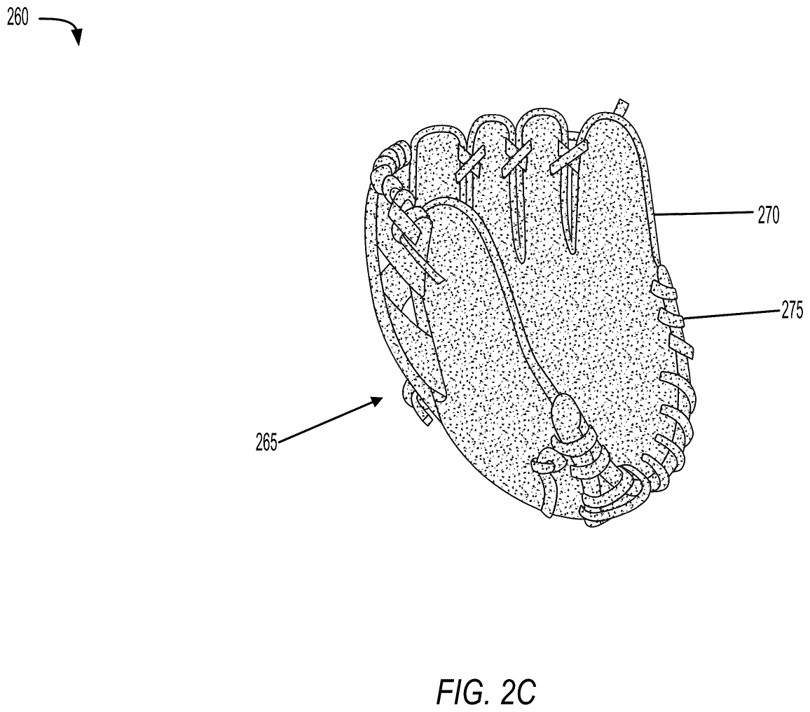

Turning next to FIGS. 2A-2C, FIGS. 2A-2C show examples of 3D surfaces used during material selection and application for 3D surface texturing using LLMs. FIGS. 2A-2C use a baseball glove as an example 3D surface. FIG. 2A shows an illustration 200 of an untextured 3D mesh 205, according to some examples of the present disclosure. The 3D mesh 205 may be specified in the 3D surface information 105. The specification of the 3D mesh 205 may include a number of vertices 210 specified using 3D coordinates (e.g., Cartesian (x, y, z) coordinates) and a number of connections or edges 215 between at least some of the vertices. Together, the vertices 210 and edges 215 define the faces 220 of the 3D mesh 205. The faces 220 of the 3D mesh 205 may be, for example, triangles or other suitable polygons. The illustration 200 is drawn without the vertices and edges visible for clarity. Illustration 200 shows an untextured, rendered baseball glove.

In some examples, textures may be applied to the 3D mesh 205 by identifying or selecting a subset of the 3D mesh 205 faces 220. For instance, the segments of the segmented 3D surface 115 may include a subset of the faces. Application of a texture or material to the segment can thus involve application of the texture or material to the subset of the faces defining the segment.

FIG. 2B shows an illustration 230 of a 3D mesh 235 textured using base textures, according to some examples of the present disclosure. The 3D mesh 235 textured using base textures may be used, for example, as additional input to the LLM 120 to provide context for a color or material suggestion. In this example, the 3D mesh 235 includes a glove segment 240 and a lace segment 245, each of which has an associated base texture.

The base textures are indicated using shading for simplicity, but in various examples, the base textures may include greyscales, colors, patterns, etc. In some examples, the base textures may themselves be generated using an algorithmic or ML-based approach. For instance, the base textures may be RGB textures characterized by a specification of a color (e.g., using three RGB values) that can be applied to the 3D surface. The textures may have lighting “baked in” and may not accurately or realistically depict the appearance of the textures under different lighting conditions or from different viewpoints.

The texture patch 250 is an example of a cropped image of a base texture that can be provided as input to the materials database 135 along with the material type 125 during the materials search. The example texture patch 250 is a zoomed-in view of the glove segment 240 with the base texture applied. The texture patch may be obtained by rendering the 3D mesh 235 from a viewpoint that is as frontal as possible. The texture patch 250 can be cropped using a square or rectangular selection from this rendering. A frontal viewpoint is one in which the line of sight from the viewpoint is approximately normal to the 3D surface at point, such that a relatively flat texture patch 250 can be cropped from the image.

FIG. 2C shows an illustration 260 of a rendered 3D surface 265 with material applied, according to some examples of the present disclosure. Materials, as applied by the rendering engine 145 as described above, include extended textures that encompass properties such as diffuse color, specular color, shininess, reflectivity, transparency, and emissive color. Materials can simulate the physical characteristics of surfaces such as metal, glass, or plastic under varying lighting conditions and/or viewpoints. In example rendered 3D surface 265, materials are applied to two segments, the glove segment 270 and the lace segment 275. For instance, the glove segment 270 may have a first type of leather material applied and the lace segment may have a segment type of leather material applied (e.g., different shades or textures of leather). The materials are indicated using shading for simplicity.

### Segmentation

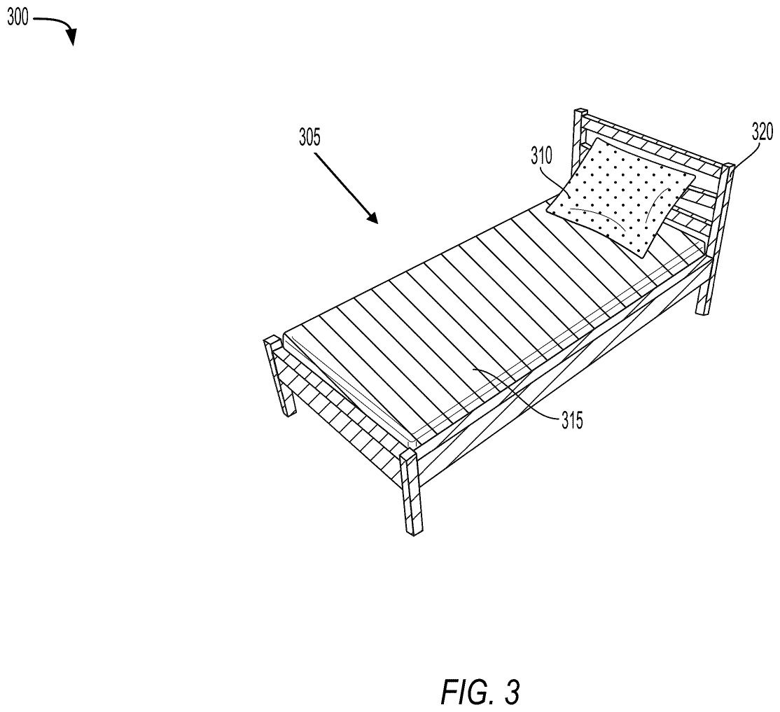

Turning next to FIG. 3, FIG. 3 shows an example of a segmented 3D surface 300, according to some examples of the present disclosure. The segmented 3D surface 300 may be similar in some respects to the segmented 3D surface 115 described above with respect to FIG. 1. The segmented 3D surface 300 is a bed 305 including segments 310, 315, and 320. Segment 310 includes the pillow, segment 315 includes the mattress, and segment 320 includes all portions of the bed frame.

In some examples, determination of the segmented 3D surfaces by a component such as the segmentation component 110 may involve determining the segments of each 3D surface using a mesh segmentation algorithm to segment the 3D mesh. For example, the mesh segmentation algorithm may be a chart-based segmentation in which the 3D mesh is subdivided into “charts” or patches, including optimizations for minimizing distortion and seam placement. Another example of a mesh segmentation algorithm includes a part-based segmentation approach in which the 3D mesh can be segmented into parts or components based on structural features of the 3D surface.

In some examples, the 3D surface information 105 may further include segmentation information about the 3D mesh. In that case, the segmentation of the 3D surface can be obtained from the 3D surface information. The segmentation information about the 3D mesh may be obtained from commercial or public 3D asset repositories (e.g., Objaverse). In these examples, the 3D surface information 105 may obtained from the repository along with the segmentation information. For example, the segmentation information may be include part-level semantic segmentation or the 3D surface may be specified as a number of disparate parts. The segmentation information may included as additional metadata along with specification of the 3D mesh.

### Prompts and Responses

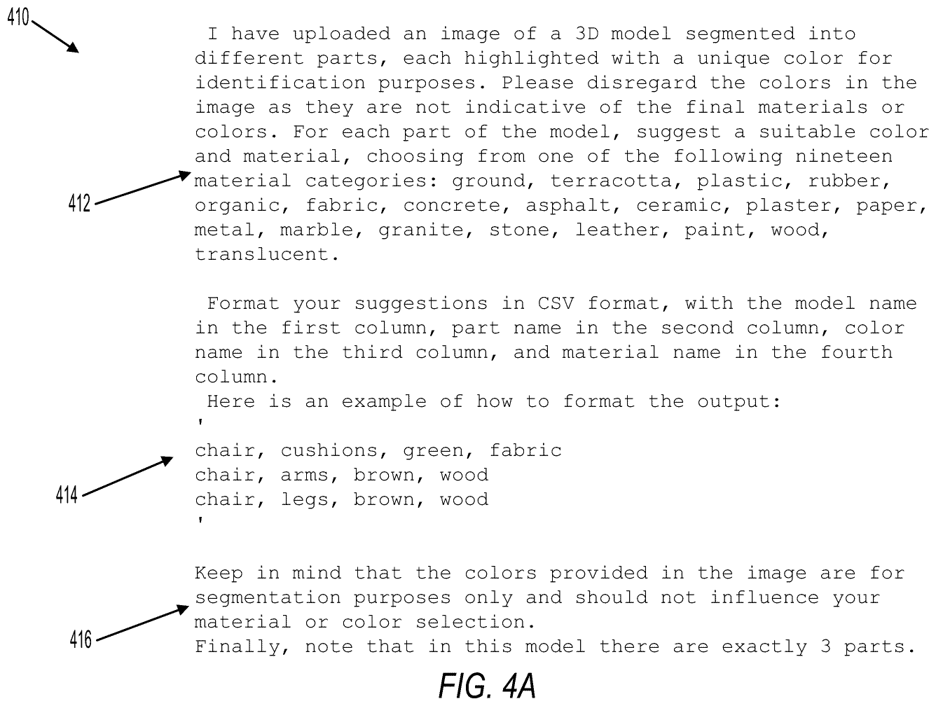

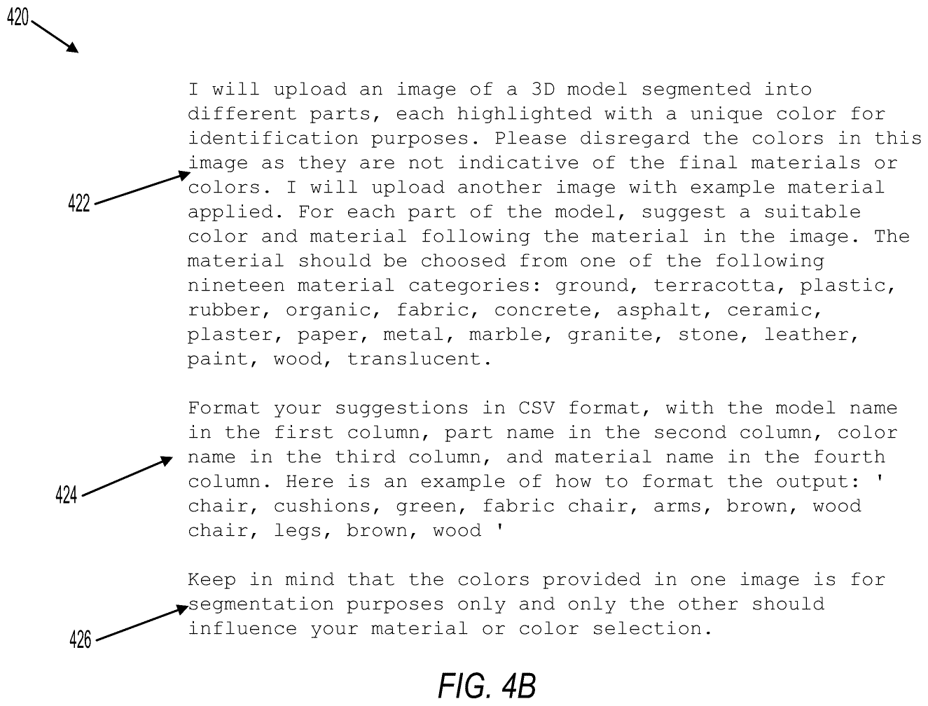

Turning next to FIGS. 4A and 4B, FIGS. 4A and 4B show example prompts for material selection and application for 3D surface texturing using LLMs, according to some examples of the present disclosure. The example prompts in FIGS. 4A and 4B are input to the LLM 120 in analogy to prompt 122 shown in FIG. 1. In FIG. 4A, the prompt 410 includes instructions 412 to respond with a material type associated with each of the one or more segments identified in the supplied rendered image of the segmented 3D surface 115. The prompt 410 also includes output format instructions 414 and additional information 416. The output format may include, for example, text that identifies the 3D surface, for each of the one or more segments, a text that identifies the segment, or a color associated with the segment.

In FIG. 4B, the prompt 420 likewise includes instructions 422, output format instructions 424, and additional information 426. Example prompt 420 differs from prompt 410 in that the instructions 422 indicate that an image of the 3D surface with the base textures applied will be supplied in addition to the segmented 3D surface 115 rendering. The inclusion of the image of the 3D surface with the base textures may provide additional context for determination of the material such as the desired color and can yield more accurate or consistent results. Other prompts in addition to these two examples may be used in various embodiments.

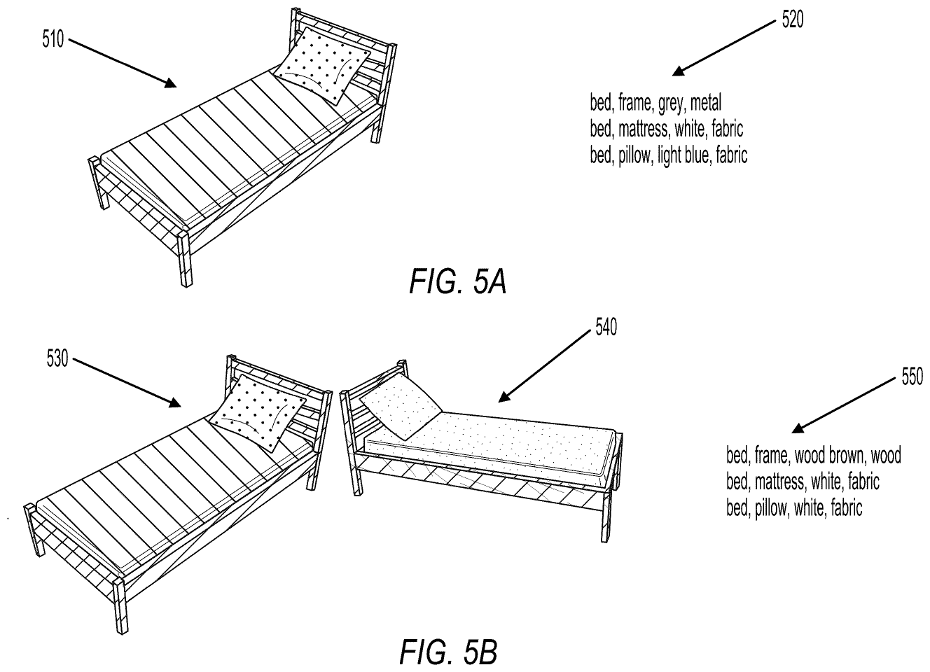

FIGS. 5A and 5B show example material type responses from an LLM for material selection and application for 3D surface, according to some examples of the present disclosure. FIG. 5A depicts an example response 520 as may be received from an LLM given the prompt 410 of FIG. 4A and the segmented 3D surface 510. The response 520 corresponds to the output format instructions 414. In one example, the LLM has identified the segmented 3D surface 510 as a bed, identified one segment as a bed frame, suggested a color of grey, and the material as metal.

FIG. 5B depicts an example output as may be received from an LLM given the prompt 420 of FIG. 4B and the segmented 3D surface 530. The prompt 420 also specifies inclusion of the 3D surface with base textures applied 540. The response 550 again corresponds to the output format instructions 424. In one example, the LLM has identified the segmented 3D surface 530 as a bed, identified one segment as a bed frame, suggested a color of wood brown, and the material as wood. In this example, the LLM response 550 was influenced by the 3D surface with base textures applied 540 and responded using a different suggested material than in response 520.

### Method for Material Selection and Application for 3D Surface Texturing Using LLMs

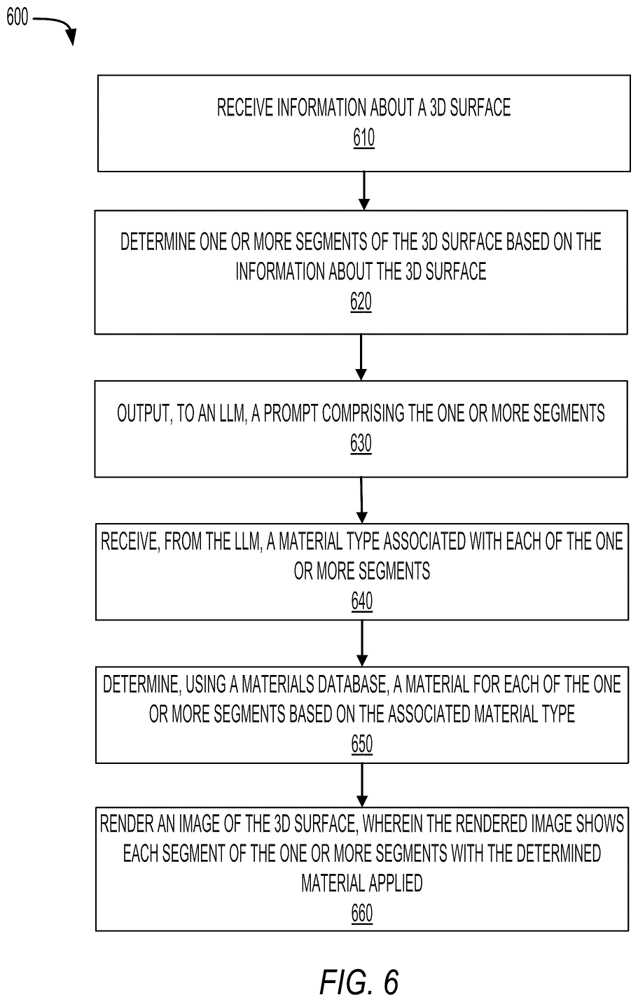

FIG. 6 is a flow diagram of an example process 600 for material selection and application for 3D surface texturing using LLMs. The process 600 depicted in FIG. 6 may be implemented in software executed by one or more processing units of a processing device, implemented in hardware, or implemented as a combination of software and hardware. This process 600 is intended to be illustrative and non-limiting. The example process herein is described with reference to the texturing system 100 depicted in FIG. 1, but other implementations are possible. Although FIG. 6 depicts various processing operations occurring in a particular order, the particular order depicted is not required. In certain alternative embodiments, the processing may be performed in a different order, some operations may be performed in parallel, or operations may be added, removed, or combined together.

At block 610, a computing system, such as texturing system 100, receives information about a 3D surface. The computing system, such as texturing system 100, may be any suitable combination of hardware or software components. The various components of the computing system may be, for example, physical servers, virtual machines, cloud computing instances, containers, or any combination thereof. The components of the computing system may be communicatively coupled using physical or wireless network connections over a local area network (“LAN”), wide-area (corporate) network (“WAN”), the Internet, or the like.

The information about the 3D surface may include, for example, the information about one or more base textures and a specification of a 3D mesh. The information about one or more base textures may include, for example, image files, procedural generation descriptions including instructions for algorithmically generating the base textures, or texture maps, and so on. The specification of the 3D mesh can include, for instance, the coordinates of a number of vertices in a suitable coordinate system and a specification of edges connecting a number of vertex pairs. The specification of the 3D mesh may include an implicit or explicit identification of a number of faces, such as polygons, that collectively constitute the inner or outer side of the 3D surface.

In some examples, the information about the 3D surface further includes segmentation information about the 3D surface. The segmentation information may, for example, identify a number of segments corresponding to different portions of the specified 3D mesh using an identification of one or more vertices or faces, or other suitable means.

At block 620, the computing system determines one or more segments of the 3D surface based on the information about the 3D surface. In examples in which the segmentation information is included with the information about the 3D surface, this operation can involve accessing the segmentation information therein. In some examples, the one or more segments of the 3D surface can be determined using a mesh segmentation algorithm. The mesh segmentation algorithm can receive as input a specification of the 3D mesh corresponding to the 3D surface and return segmentation information, including an identification of one or more subsets of the vertices or faces of the 3D mesh, each subset corresponding to a segment. The segments are not necessarily contiguous. For instance, a single segment may include multiple subsets of vertices or faces (e.g., the numerous laces of the baseball glove of FIGS. 4A-4C may together constitute a single segment).

At block 630, the computing system provides, to an LLM, a prompt comprising the one or more segments. For example, the computing system can generate the prompt for the LLM including instructions to identify the material type for each of the one or more segments. The prompt may include a rendered image of the 3D surface based on the specification of the 3D mesh and the one or more segments. In some examples, the prompt may be accompanied by additional images such as a rendering of the 3D surface with the base textures included.

The LLM in example texturing system 100 is shown as a component of the texturing system 100, but in various examples, the LLM 120 may be a standalone component hosted in another server or in a cloud computing environment. The LLM 120 may be, for instance, a self-hosted LLM such as the open-source Llama (“Large Language Model Meta AI”) series provided by Meta. In some examples, the LLM 120 may be hosted by a third-party and accessed over a network using a suitable API such as the Generative Pre-trained Transformers (“GPT”) series provided by OpenAI. Many other LLMs in addition to these non-limiting examples can be used.

In some examples, for instance, GPT-4V (“GPT-4 with Vision”) may be used to enable responses that utilize both global context provided via the text prompt and input images as well as local visual cues in the input images. Given an image of the 3D surface and the segmentation information, GPT-4V can be prompted to suggest different material categories or types corresponding to the different segments of the 3D surface.

At block 640, the computing system receives, from the LLM, a material type associated with each of the one or more segments. For example, the LLM may output a material type identified from a list of possible material types. The list of possible material types may correspond to material types used to categorize material types available in the materials database. In some examples, the material type can be identified without constraint. An example LLM output conforming to a specified output in the prompt for an image of a bed is “bed, frame, wood brown, wood,” corresponding to the identity of the 3D surface, the identity of the segment, the color of the segment, and the determined material type.

At block 650, the computing system determines, using a materials database, a material for each of the one or more segments based on the associated material type. For example, the materials database can be queried given input such as the material type and additional information about the desired match. In some examples, the material search using the material database can use a Contrastive Language-Image Pre-training (“CLIP”) feature similarity search in concert with color histograms to find matching materials. The CLIP feature similarity search may use an ML model based on the CLIP algorithm, which can be used to generate embedded representations of images of input base textures as well as the materials in the materials database. The CLIP feature similarity search can be trained to identify or rank materials based on their visual and semantic similarity to the input material type. This approach can ensure that the selected materials not only visually align with the desired aesthetic but also meet the functional requirements for realistic rendering on the 3D surface.

In some examples, for each of the one or more segments, a rendered image of the 3D surface including the base textures can be used to determine a sub-image or “patch” for each segment that showcases the base texture applied to the particular segment. The patch is then input to the materials database along with the material type. For example, the segmented 3D surface with the base textures can be rendered from a viewpoint that provides at least one substantially parallel surface to the plane of the image. From this rendering, a portion (e.g., a square patch) can be obtained (e.g., cropped). The square patch that includes an image of the base texture can be used to perform a material search based on the visual cues provided by the patch among the materials in the materials database that belong to the same category as the material type suggested by the LLM 120.

In one example implementation, to prepare the materials database for use with the CLIP similarity search, each material in the materials database can be rendered on a flat surface with neutral illumination. For each material, the CLIP image embedding features as well as color histograms for each material rendering can be determined. The CLIP image embedding features may be, for example, high-dimensional vectors that represent the semantic content of the rendered material.

The color histograms may be 3D histograms in the La*b* space with 8 bins for L and 32 for each of a* and b*. The La*b* color space is a specific organization of colors designed to approximate human vision. The L* channel represents lightness and the a* and b* channels represent color-opponent dimensions (e.g., the a* dimension represents green and red, while the b* dimension represents blue and yellow). In some examples, the L axis may be divided into 8 bins and the a* and b* axes may be divided into 32 bins. The color histograms are developed by counting the number of pixels in the input image that fall within each bin defined by a L, a*, and b* coordinate.

In some examples, only a subset of the colors in the rendered materials can be used to optimize the pre-processing and similarity matching. For instance, extracting the 7 most prominent colors in each rendered material to develop a color histogram may be a sufficient representation for high-quality retrieval in most cases.

To perform the CLIP similarity search, a CLIP image embedding and color histogram of the patch of the rendering of the segment can be computed, similarly to the procedure described above for the materials in the materials database. The CLIP similarity can be computed as the distance of the patch to each of the materials of the specified material type. The distance can be computed both using the vector distance d_{clip} between the image embedding of the patch with each respective material, as well as the distance d_{color} between the color histogram of the patch and the color histogram of each respective material. The distance d_{color} can be computed using a suitable computation technique for computing the difference between distributions (e.g., probability distributions) such as the Sinkhorn relaxation of the Earth Mover Distance.

In some examples, the computed distances d_{clip} and d_{color} can be normalized to be in a specified range such as the range 0 through 1, inclusive. Normalization can be based on various constants, such as the maximum distance between the patch and all other materials or all other materials for a particular material type. A final distance can be computed as linear combination of the two distances d_{clip} and d_{color}:d=d_{clip}·(1−w)+d_{color}·w. In this equation the weight w can be used to control how much the similarity search should be influenced by color similarity. For instance, the weight w may be set to a value of approximately 0.8, but other values may be used according to the particular application. The material in the material database identified using the CLIP similarity search may be the material that has the smallest distance d to each segment.

At block 660, the computing system renders an image of the 3D surface, wherein the rendered image shows each segment of the one or more segments with the determined material applied. In general, application of the determined material may involve one or more processing steps such as scaling or normalization to optimize the realistic appearance of the rendered material.

The determined material may be received, from the materials database, as a tileable image or other suitable representation. A tileable material can be repeated or “tiled” without the appearance of seams or other distortions at the boundaries of tiled images. The tileable determined material may be scaled based on the apparent size of the materials relative to the size the 3D surface. In some examples, the 3D surface information 105 may include additional information or metadata about the 3D surface size for the purpose of texture scaling. For instance, information about the 3D surface size may be included along with the 3D mesh specification when obtained from high-quality asset libraries. In some examples, when such information is not available, the LLM 120 can be prompted to estimate or otherwise determine information about the size of the 3D surface.

To apply the determined material to the 3D surface, a two-dimensional (“2D”) area of a tile of the material retrieved from the materials database can be used to determine a tiling factor to apply the selected material so that it matches the size of the segment. The tiling factor can be computed to align the physical sizes of the mesh part and the material. For example, the tiling factor can be used to compute a scaling factor to apply in one or more axes of a tile of the determined material. A tiling factor of less than one may correspond to “zoom in” operation while a tiling factor of greater than one may correspond to a “zoom out” operation.

In one example computation, to determine the tiling factor for a 3D surface of size Φ_{xy}, the area of a segment of the 3D surface Aₘₑₛₕ and the 2D area of the determined material Aw for each respective segment of the 3D surface are used. In this example, uv refers to the 2D coordinate system of the 2D profile of each determined material. An average texel ratio for the 3D surface can be computed by averaging a texel ratio computed for each segment to which a particular material has been assigned. For example, the average texel ratio may be given, in some examples, by:

$$texelRatio = \frac{{\sum }_{i = 1}^{N} \frac{{A}_{uv}^{i}}{{A}_{mesh}^{i}}}{N}$$

in which the summations are over the total number of segments to which the material has been assigned. The tiling factor of the material is then obtained using:

$${tilingFactor}_{xy} = \frac{\sqrt{1 / texelRatio}}{{Φ}_{xy}} .$$

The material tiles retrieved from the materials database may also have a height dimension, characterized by a height map. The height map can provide the per-pixel displacement scalar for the determined material that represents a relative difference between texels of the same height map. For example, a material that is a fuzzy fabric may have a height map that characterizes the height of the fuzz strands. However, the height maps among the materials in the materials database may not be standardized. For instance, a rendered height map may be multiplied by a global scaling factor to scale the information provided by the height map to be within a meaningful range for the considered material. In that case, the height maps may not be comparable in an absolute way. The height maps of the materials retrieved for each respective segment can be normalized, to maintain an appearance of uniformity and enable meaningful visual comparisons of surface details across different segments of the 3D surface.

In some examples, the height maps can be normalized using the “normal intensity” for each material. For each determined material, the associated height map (Hₘₐₜ) and normal map (Nₘₐₜ) can be rendered. For the normal map, each value in Nₘₐₜ is normalized. Another normal map can be computed by differentiating the height map to obtain N_{height}. To compute N_{height} a scaling factor can be used to drive the intensity of the resulting normal map N_{height}. A grid search can be performed to determine an optimized scaling factor to apply to the height map. The optimized scaling factor may be one that minimizes the L1 difference between Nₘₐₜ and N_{height}. Normalization can also be improved by requiring the mid level of the height maps to be centered at approximately 0.5.

In some examples, a tri-planar projection can be used to project the scaled and normalized tiled materials onto the 3D surface, in which the material is projected from three orthogonal planes instead of just one. Use of a tri-planar projection may minimize the appearance of seams in the rendered image. In some examples, the applied materials for each segment can be “blended” together at segment boundaries to obtain a single texture set for the entire object. In some examples, the applied materials may be kept separate to allow for further editing of each textured segment.

Given the specified 3D mesh of the 3D surface and information about the application of the determined materials to the segments of the 3D surface, the 3D surface can be rendered with the material applied from a particular viewpoint with specified lighting conditions. Rendering methods can include ray tracing, rasterization, path tracing, or other rendering methods.

### Computing Environment

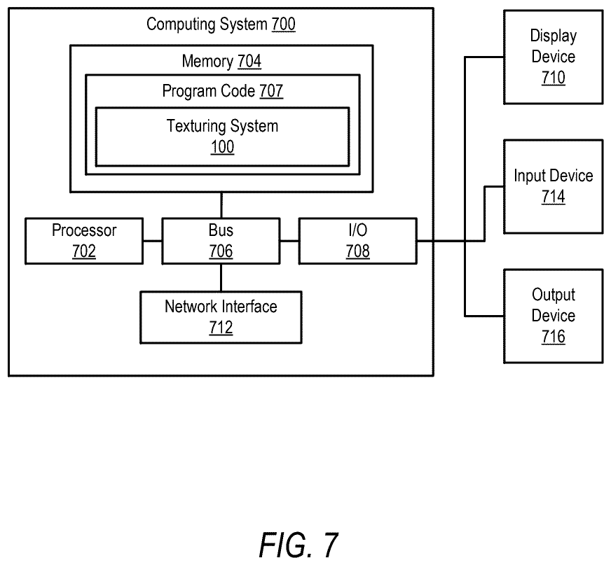

Any suitable computer system or group of computer systems can be used for performing the operations described herein. For example, FIG. 7 depicts an example of a computer system 700 used in some examples for material selection and application for 3D surface texturing using LLMs, according to some aspects of the present disclosure. The depicted example of the computer system 700 includes a processor 702 communicatively coupled to one or more memory devices 704. The processor 702 executes computer-executable program code stored in a memory device 704, accesses information stored in the memory device 704, or both. Examples of the processor 702 include a microprocessor, an application-specific integrated circuit (“ASIC”), a field-programmable gate array (“FPGA”), or any other suitable processing device. The processor 702 can include any number of processing devices, including a single processing device.

The memory device 704 includes any suitable non-transitory computer-readable medium for storing program code 707, or both. A computer-readable medium can include any electronic, optical, magnetic, or other storage device capable of providing a processor with computer-readable instructions or other program code. Non-limiting examples of a computer-readable medium include a magnetic disk, a memory chip, a ROM, a RAM, an ASIC, optical storage, magnetic tape or other magnetic storage, or any other medium from which a processing device can read instructions. The instructions may include processor-specific instructions generated by a compiler or an interpreter from code written in any suitable computer-programming language, including, for example, C, C++, C #, Visual Basic, Java, Python, Perl, JavaScript, and ActionScript. In various examples, the memory device 704 can be volatile memory, non-volatile memory, or a combination thereof.

The computer system 700 executes program code 707 that configures the processor 702 to perform one or more of the operations described herein. Examples of the program code 707 include, in various embodiments, the texturing system 100 including the several components described in FIG. 1, which may include any other suitable systems or subsystems that perform one or more operations described herein (e.g., one or more ML models, storage systems, controllers, or function-specific modules). The program code 707 may be resident in the memory device 704 or any suitable computer-readable medium and may be executed by the processor 702 or any other suitable processor.

The processor 702 is an integrated circuit device that can execute the program code 707. The program code 707 can be for executing an operating system, an application system or subsystem, or both. When executed by the processor 702, the instructions cause the processor 702 to perform operations of the program code 707. When being executed by the processor 702, the instructions are stored in a system memory, possibly along with data being operated on by the instructions. The system memory can be a volatile memory storage type, such as a Random Access Memory (RAM) type. The system memory is sometimes referred to as Dynamic RAM (DRAM) though need not be implemented using a DRAM-based technology. Additionally, the system memory can be implemented using non-volatile memory types, such as flash memory.

In some embodiments, one or more memory devices 704 store the program code 707 that includes one or more datasets described herein. In some embodiments, one or more of data sets are stored in the same memory device (e.g., one of the memory devices 704). In additional or alternative embodiments, one or more of the programs, data sets, models, and functions described herein are stored in different memory devices 704 accessible via a data network. One or more buses 706 are also included in the computer system 700. The buses 706 communicatively couple one or more components of a respective one of the computer system 700.

In some embodiments, the computer system 700 also includes a network interface device 712. The network interface device 712 includes any device or group of devices suitable for establishing a wired or wireless data connection to one or more data networks. Non-limiting examples of the network interface device 712 include an Ethernet network adapter, a modem, and/or the like. The computer system 700 is able to communicate with one or more other computing devices via a data network using the network interface device 712.

The computer system 700 may also include a number of external or internal devices, an input device 714, an output device 716, or other input or output devices. For example, the computer system 700 is shown with one or more input/output (“I/O”) interfaces 708. An I/O interface 708 can receive input from input devices or provide output to output devices. An input device 714 can include any device or group of devices suitable for receiving visual, auditory, or other suitable input that controls or affects the operations of the processor 702. Non-limiting examples of the input device 714 include a touchscreen, a mouse, a keyboard, a microphone, a separate mobile computing device, etc. An output device 716 can include any device or group of devices suitable for providing visual, auditory, or other suitable sensory output. Non-limiting examples of the output device 716 include a touchscreen, a monitor, a speaker, a separate mobile computing device, etc.

Although FIG. 7 depicts the input device 714 and the output device 716 as being local to the computer system 700, other implementations are possible. For instance, in some embodiments, one or more of the input device 714 and the output device 716 can include a remote client-computing device that communicates with computing system 700 via the network interface device 712 using one or more data networks described herein.

Embodiments may comprise a computer program that embodies the functions described and illustrated herein, wherein the computer program is implemented in a computer system that comprises instructions stored in a machine-readable medium and a processor that executes the instructions. However, it should be apparent that there could be many different ways of implementing embodiments in computer programming, and the embodiments should not be construed as limited to any one set of computer program instructions. Further, a skilled programmer would be able to write such a computer program to implement an embodiment of the disclosed embodiments based on the appended flow charts and associated description in the application text. Therefore, disclosure of a particular set of program code instructions is not considered necessary for an adequate understanding of how to make and use embodiments. Further, those skilled in the art will appreciate that one or more aspects of embodiments described herein may be performed by hardware, software, or a combination thereof, as may be embodied in one or more computer systems. Moreover, any reference to an act being performed by a computer should not be construed as being performed by a single computer as more than one computer may perform the act.

The example embodiments described herein can be used with computer hardware and software that perform the methods and processing functions described previously. The systems, methods, and procedures described herein can be embodied in a programmable computer, computer-executable software, or digital circuitry. The software can be stored on computer-readable media. For example, computer-readable media can include a floppy disk, RAM, ROM, hard disk, removable media, flash memory, memory stick, optical media, magneto-optical media, CD-ROM, etc. Digital circuitry can include integrated circuits, gate arrays, building block logic, field programmable gate arrays (FPGA), etc.

### General Considerations

The example systems, methods, and acts described in the embodiments presented previously are illustrative, and, in alternative embodiments, certain acts can be performed in a different order, in parallel with one another, omitted entirely, and/or combined between different example embodiments, and/or certain additional acts can be performed, without departing from the scope and spirit of various embodiments. Accordingly, such alternative embodiments are included within the scope of claimed embodiments.

Although specific embodiments have been described above in detail, the description is merely for purposes of illustration. It should be appreciated, therefore, that many aspects described above are not intended as required or essential elements unless explicitly stated otherwise. Modifications of, and equivalent components or acts corresponding to, the disclosed aspects of the example embodiments, in addition to those described above, can be made by a person of ordinary skill in the art, having the benefit of the present disclosure, without departing from the spirit and scope of embodiments defined in the following claims, the scope of which is to be accorded the broadest interpretation so as to encompass such modifications and equivalent structures.

Numerous specific details are set forth herein to provide a thorough understanding of the claimed subject matter. However, those skilled in the art will understand that the claimed subject matter may be practiced without these specific details. In other instances, methods, apparatuses, or systems that would be known by one of ordinary skill have not been described in detail so as not to obscure claimed subject matter.

Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provide a result conditioned on one or more inputs. Suitable computing devices include multi-purpose microprocessor-based computer systems accessing stored software that programs or configures the computer system from a general purpose computing apparatus to a specialized computing apparatus implementing one or more embodiments of the present subject matter. Any suitable programming, scripting, or other type of language or combinations of languages may be used to implement the teachings contained herein in software to be used in programming or configuring a computing device.

Embodiments of the methods disclosed herein may be performed in the operation of such computing devices. The order of the blocks presented in the examples above can be varied—for example, blocks can be re-ordered, combined, and/or broken into sub-blocks. Certain blocks or processes can be performed in parallel.

The use of “adapted to” or “configured to” herein is meant as an open and inclusive language that does not foreclose devices adapted to or configured to perform additional tasks or steps. Where devices, systems, components or modules are described as being configured to perform certain operations or functions, such configuration can be accomplished, for example, by designing electronic circuits to perform the operation, by programming programmable electronic circuits (such as microprocessors) to perform the operation such as by executing computer instructions or code, or processors or cores programmed to execute code or instructions stored on a non-transitory memory medium, or any combination thereof. Processes can communicate using a variety of techniques including but not limited to conventional techniques for inter-process communications, and different pairs of processes may use different techniques, or the same pair of processes may use different techniques at different times.

Additionally, the use of “based on” is meant to be open and inclusive, in that, a process, step, calculation, or other action “based on” one or more recited conditions or values may, in practice, be based on additional conditions or values beyond those recited. Headings, lists, and numbering included herein are for ease of explanation only and are not meant to be limiting.

While the present subject matter has been described in detail with respect to specific embodiments thereof, it will be appreciated that those skilled in the art, upon attaining an understanding of the foregoing, may readily produce alterations to, variations of, and equivalents to such embodiments. Accordingly, it should be understood that the present disclosure has been presented for purposes of example rather than limitation, and does not preclude the inclusion of such modifications, variations, and/or additions to the present subject matter as would be readily apparent to one of ordinary skill in the art.

1. A method, comprising:
receiving information about a three-dimensional (“3D”) surface;
determining one or more segments of the 3D surface based on the information about the 3D surface;
providing, to a large language model (“LLM”), a prompt comprising the one or more segments;
receiving, from the LLM, a material type associated with each of the one or more segments;
determining, using a materials database, a material for each of the one or more segments based on the associated material type; and
rendering an image of the 3D surface, wherein the rendered image shows each segment of the one or more segments with the determined material applied.

2. The method of claim 1, wherein the material type associated with each of the one or more segments further includes:
a first text that identifies the 3D surface; and
for each of the one or more segments:
a second text that identifies the segment; and
a color associated with the segment.

3. The method of claim 1, wherein the information about the 3D surface comprises information about one or more base textures and a specification of a 3D mesh.

4. The method of claim 3, wherein:
the information about the 3D surface further comprises segmentation information about the 3D mesh; and
determining the one or more segments of the 3D surface comprises accessing the segmentation information from the information about the 3D surface.

5. The method of claim 3, wherein determining the one or more segments of the 3D surface comprises using a mesh segmentation algorithm to segment the 3D mesh.

6. The method of claim 3, wherein providing, to the LLM, the prompt comprising the one or more segments comprises:
generating the prompt for the LLM including instructions to identify the material type for each of the one or more segments;
rendering a second image of the 3D surface based on the specification of the 3D mesh and the one or more segments; and
providing, to the LLM, the second image of the 3D surface and the prompt.

7. The method of claim 6, further comprising rendering a third image of the 3D surface based on the information about the one or more base textures and wherein providing, to the LLM, further includes the third image.

8. The method of claim 3, wherein determining, using the materials database, the material for each of the one or more segments based on the associated material type comprises:
for each of the one or more segments:
rendering a second image of the 3D surface based on the specification of the 3D mesh, the one or more segments, and information about a texture of the one or more base textures; and
determining a sub-image of the second image, the second image including the texture; and
wherein determining, using the materials database, the material for each of the one or more segments based on the associated material type is based on the sub-images.

9. The method of claim 8, wherein determining, using the materials database, the material for each of the one or more segments based on the associated material type is further based on a feature similarity and a color histogram associated with each of the sub-images.

10. The method of claim 3, wherein rendering the image of the 3D surface comprises:
for each of the one or more segments:
determining a subset of the 3D mesh corresponding to the segment;
scaling the determined material based on a size of the segment;
normalizing a height of the determined material based on the one or more determined materials; and
applying the normalized determined material to the subset of the 3D mesh.

11. A system comprising:
one or more processors; and
one or more computer-readable storage media storing instructions which, when executed by the one or more processors, cause the one or more processors to perform operations including:
receiving information about a three-dimensional 3D surface, comprising information about one or more base textures and a specification of a 3D mesh;
determining one or more segments of the 3D surface based on the information about the 3D surface;
determining, using an LLM, a material type associated with each of the one or more segments;
determining, using a materials database, a material for each of the one or more segments based on the associated material type; and
rendering an image of the 3D surface, wherein the rendered image shows each segment of the one or more segments with the determined material applied.

12. The system of claim 11, wherein determining, using the LLM, the material type associated with each of the one or more segments comprises:
generating a prompt for the LLM including instructions to identify the material type for each of the one or more segments;
rendering a second image of the 3D surface based on the specification of the 3D mesh and the one or more segments;
providing, to the LLM, the second image of the 3D surface and the prompt; and
receiving, from the LLM, the material type for each of the one or more segments.

13. The system of claim 12, wherein the material type further includes:
a first text that identifies the 3D surface; and
for each of the one or more segments:
a second text that identifies the segment; and
a color associated with the segment.

14. The system of claim 11, wherein determining, using the materials database, the material for each of the one or more segments based on the associated material type comprises:
for each of the one or more segments:
rendering a second image of the 3D surface based on the specification of the 3D mesh, the one or more segments, and information about a texture of the one or more base textures; and
determining a sub-image of the second image, the second image including the texture; and
wherein determining, using the materials database, the material for each of the one or more segments based on the associated material type is based on the sub-images.

15. The system of claim 14, wherein determining, using the materials database, the material for each of the one or more segments based on the associated material type is further based on a feature similarity and a color histogram associated with each of the sub-images.

16. A non-transitory computer-readable medium storing instructions that, when executed by one or more processors, cause the one or more processors to perform operations including:
receiving information about a 3D surface, comprising information about one or more base textures and a specification of a 3D mesh;
a step for determining one or more segments of the 3D surface based on the information about the 3D surface;
a step for providing, to an LLM, a prompt comprising the one or more segments;
receiving, from the LLM, a material type associated with each of the one or more segments;
a step for determining, using a materials database, a material for each of the one or more segments based on the associated material type; and
a step for rendering an image of the 3D surface, wherein the rendered image shows each segment of the one or more segments with the determined material applied.

17. The non-transitory computer-readable medium of claim 16, wherein the step for determining the one or more segments of the 3D surface based on the information about the 3D surface comprises using a mesh segmentation algorithm to segment the 3D mesh.

18. The non-transitory computer-readable medium of claim 16, wherein the step for providing the prompt comprising the one or more segments comprises:
generating the prompt for the LLM including instructions to identify the material type for each of the one or more segments;
rendering a second image of the 3D surface based on the specification of the 3D mesh and the one or more segments; and
providing, to the LLM, the second image of the 3D surface and the prompt.

19. The non-transitory computer-readable medium of claim 16, wherein the step for determining, using the materials database, the material for each of the one or more segments based on the associated material type comprises:
for each of the one or more segments:
rendering a second image of the 3D surface based on the specification of the 3D mesh, the one or more segments, and information about a texture of the one or more base textures; and
determining a sub-image of the second image, the second image including the texture; and
wherein determining, using the materials database, the material for each of the one or more segments based on the associated material type is based on the sub-images.

20. The non-transitory computer-readable medium of claim 16, wherein the step for rendering the image of the 3D surface comprises:
for each of the one or more segments:
determining a subset of the 3D mesh corresponding to the segment;
scaling the determined material based on a size of the segment;
normalizing a height of the determined material based on the one or more determined materials; and
applying the normalized determined material to the subset of the 3D mesh.
